(19) United States
(12) Patent Application Publication
(10) Pub. No.: US 2015/0032911 A1
(43) Pub. Date: Jan. 29, 2015

(54) MONITORING APPARATUS FOR MONITORING INTER-INTEGRATED CIRCUIT BUS

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: HONG-RU ZHU, Shenzhen (CN)

(21) Appl. No.: 14/337,968

(22) Filed: Jul. 22, 2014

(30) Foreign Application Priority Data
Jul. 25, 2013 (CN) 2013103146049

(51) Int. Cl. G06F 11/30

(52) U.S. Cl. CPC G06F 11/3027; G06F 11/3051; G06F 2211/002
USPC 710/18

(57) ABSTRACT

A monitoring device connects to a serial data line (SDA) and a serial clock line (SCL) of an 12C bus. The monitoring device analyzes the data signals and clock signals transmitted on the 12C bus, samples data signals from the serial data line at time intervals, and stores the sampled data in a storage unit. The data stored in the storage unit is displayed via a display unit or via a computing device connected to the monitoring device.

### CROSS-REFERENCE TO RELATED APPLICATIONS

This application claims priority to Chinese Patent Application No. 201310314604.9 filed on Jul. 25, 2013 in the Chinese Intellectual Property Office, the contents of which are incorporated by reference herein.

### FIELD

Embodiments of the present disclosure generally relate to a monitoring apparatus for monitoring inter-integrated circuit (I²C) bus of computing devices.

### BACKGROUND

Digital oscilloscopes can be used to monitor communication data on an inter-integrated circuit (I²C) bus while testing or debugging the I²C bus to determine if the communication of the I²C is normal. However, the digital oscilloscopes are expensive.

### BRIEF DESCRIPTION OF THE DRAWINGS

Implementations of the present technology will now be described, by way of example only, with reference to the attached figures.

FIG. 1 is a block diagram of a monitoring apparatus for monitoring an inter-integrated circuit (I²C) bus according to a first embodiment.

FIG. 2 is a block diagram of a monitoring apparatus for monitoring the (I²C) bus according to a second embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The term “unit” used herein can be either software module or hardware module. A non-limiting example of the “unit” can be an integrated circuit or an integrated chip with software programs or firmware embedded therein.

The present disclosure is described in relation to an apparatus for monitoring an inter-integrated circuit (I²C) bus.

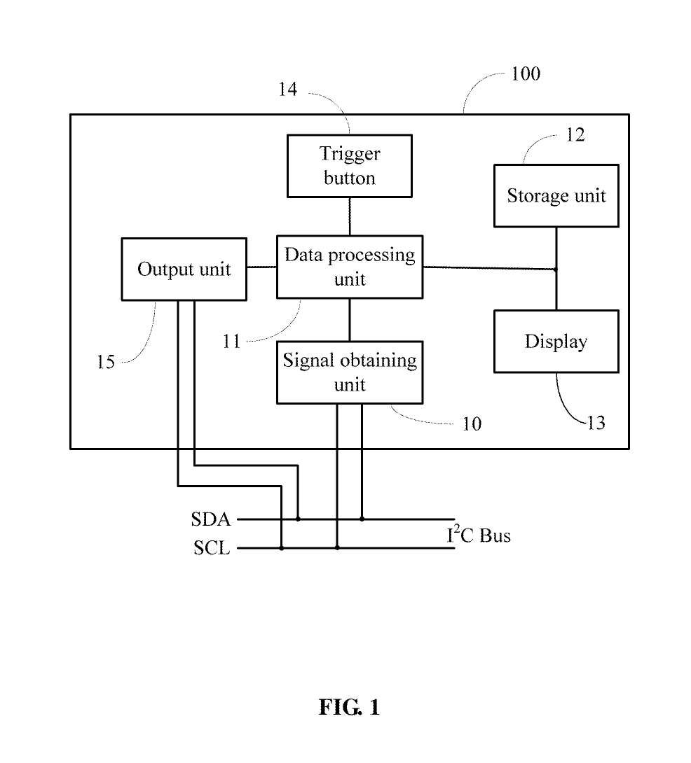

FIG. 1 illustrates a block diagram of a monitoring apparatus 100 for monitoring an inter-integrated circuit (I²C) bus according to a first embodiment. The monitoring apparatus 100 includes a signal obtaining unit 10, a data processing unit 11, a storage unit 12, a display 13, a switch 14, and an output unit 15. In at least one embodiment, the data processing unit 11 can be a complex programmable logic device (CPLD) chip or a digital signal processing (DSP) chip, which is electrically coupled to the signal obtaining unit 10, the storage unit 12, the display 13, the switch 14, and the output unit 15.

The signal obtaining unit 11 is electrically coupled with both a serial data (SDA) line and a serial clock (SCL) line of an I²C bus, and is configured to obtain data signals and clock signals transmitted by the I²C bus. In at least one embodiment, the signal obtaining unit 10 can include a current isolator to isolate current signals of the data signals and the clock signals, and then transmit the isolated data signals and clock signals to the data processing unit 11.

The data processing unit 11 analyzes the data signals and the clock signals obtained by the signal obtaining unit 10, and samples the data signals at time intervals. The sampled data signals are stored in the storage unit 12. The storage unit 12 can be a static random access memory (SRAM). Each time interval can be a high period or a low period of the clock signals.

In at least one embodiment, the data processing unit 11 first detects a start signal from the data signals and the clock signals obtained by the signal obtaining unit 10, and records the start signal using a first digital number such as “0x01”. The start signal denotes the beginning of a new data transfer. The start signal is defined as a high-to-low transition of the SDA line while the SCL line is in a high level (e.g., logical “1”). The first digital number is stored in the storage unit 12 representing the start signal. Then, when the start signal is detected, the data processing unit 11 samples each byte of the data signals and an acknowledge (ACK) bit following each byte of the data signals during each high period of the clock signals. Each byte of the data signals sampled by the data processing unit 11 are stored in odd addresses (e.g., X0001, X0003, X0005) of a predetermined storage section storage unit 12. Further, the data processing unit 11 detects if the ACK bit following each byte of the sampled data signals is high or low. If the ACK bit is low, the data processing unit 11 records the ACK bit in the storage unit 12 using a second digital number such as 0X02. If the

ACK bit is high, the data processing unit 11 records the ACK bit in the storage unit 12 using a third digital number such as 0X03. The second and third digital numbers are recorded in even addresses of the predetermined storage section of the storage unit 12. The ACK bit indicates if or not a slave device that is connected on the I²C bus has a response to a master device that is connected on the I²C bus. For example, if the ACK bit is “1” the slave device has no response to the master device. If the ACK bit is “0” the slave device has returned a response to the master device.

When a stop signal is detected by the data processing unit 11, the data processing unit 11 records the stop signal in the storage unit 12 using a fourth digital number such as 0X00. The stop signal is defined as a low-to-high transition of the SDA line while the SCL line is at logical “1”.

The display 13 is electrically coupled to the storage unit 12 and is configured to display data stored in the storage unit 12. Thus, the communication state of the I²C bus can be manually monitored according to the displayed data on the display 13. The display 13 can be a liquid crystal display (LCD) or a light emitting diode (LED) display.

The trigger button 14 is electrically coupled to the data processing unit 11 and configured to send a trigger signal to the data processing unit 11 when the trigger button 14 is operated. The data processing unit 11 starts or stops to sample the data signals of the I²C bus according to the trigger signal.

The data output unit 15 is further electrically coupled to the I²C bus and is configured to output the data stored in the storage unit 12 to the slave device connected on the I²C bus to control the slave device to perform corresponding operations. Thus, the monitoring apparatus 100 can simulate a master device connected on the I²C bus.

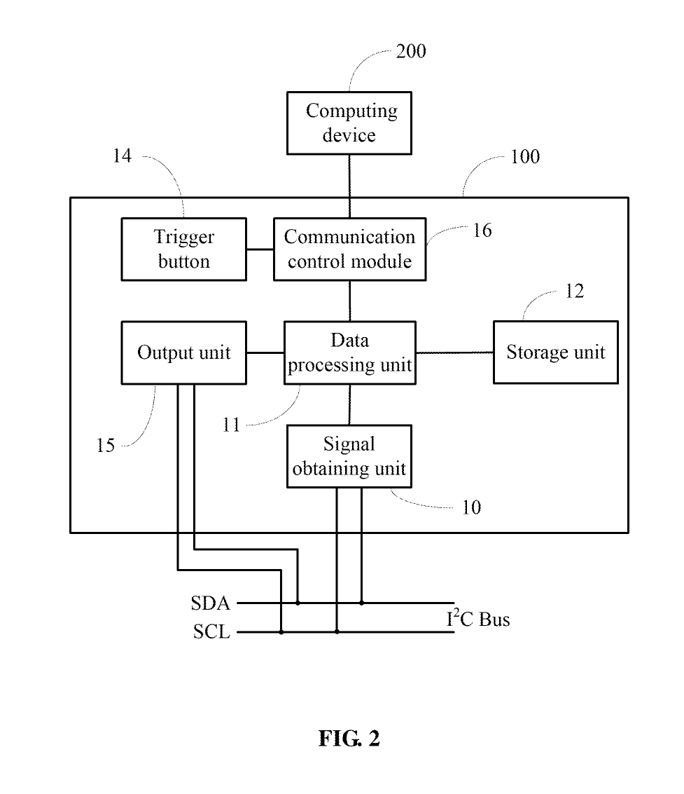

FIG. 2 illustrates a second embodiment of the monitoring apparatus 100. The monitoring apparatus in the second embodiment is similar to that in the first embodiment, except that the monitoring apparatus 100 further includes a communication control unit 16 electrically coupled to the data processing unit 11 and the trigger button 14. The trigger signal output from the trigger button 14 is first received by the communication control unit 16 and then transmitted to the data processing unit 11 via the signal obtaining unit 10.

In addition, the display 13 is omitted in the second embodiment. The communication control unit 16 is electrically communicating with a computing device 200. The communication control unit 16 acquires the data stored in the storage unit 12 and transmits the data to the computing device 200 to display via a display device (e.g., an LCD). In at least one embodiment, the communication control unit 16 can communicate with the computing device 200 via a universal serial bus (USB) interface or a serial interface. The communication control unit 16 can be an integrated chip or a microprocessor.

The computing device 200 can send a control command to the communication control unit 16. The control command can be then transmitted to the data processing unit 11 controlling the data processing unit 11 to start or stop sampling the data signals from the I²C bus.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A monitoring apparatus for monitoring an inter integrated circuit (I²C) bus, the monitoring apparatus comprising:
a signal obtaining unit, a data processing unit, a storage unit and a display, the data processing unit coupled to the signal obtaining unit, the storage unit, and the display, wherein:
the signal obtaining unit is further coupled with both a serial data (SDA) line and a serial clock (SCL) line of the (I²C) bus, and is configured to obtain data signals and clock signals transmitted by the I²C bus;
the data processing unit is configured to analyze the data signals and the clock signals obtained by the signal obtaining unit, sample the obtained data signals at time intervals, and store the sampled data in the storage unit; and
the display is configured to display the data stored in the storage.

2. The monitoring apparatus according to claim 1, further comprises a data output unit electrically coupled to the I²C bus and configured to output the data stored in the storage unit to a slave device connected on the I²C bus to control the slave device to perform corresponding operations.

3. The monitoring apparatus according to claim 1, wherein the data processing unit is further configured to:
detect a start signal from the data signals and the clock signals obtained by the signal obtaining unit and record the start signal using a first digital number;
sample each byte of the data signals and an acknowledge (ACK) bit following each byte of the data signals during each high period of the clock signals;
detect if the ACK bit following each byte of the sampled data signals is high or low, record the ACK bit in the storage unit using a second digital number if the ACK bit is low, and record the ACK bit in the storage unit using a third digital number the data processing unit 11 if the ACK bit is high; and
record a stop signal in the storage unit using a fourth digital number when the stop signal is detected by the data processing unit.

4. The monitoring apparatus according to claim 3, wherein the first, second, third, an fourth digital numbers are stored in even addresses of a predetermined storage section of the storage unit, and each byte of the data signals sampled by the data processing unit are stored in odd addresses of the predetermined storage section storage unit.

5. The monitoring apparatus according to claim 1, further comprising a trigger button electrically coupled to the data processing unit and configured to send a trigger signal to the data processing unit when the trigger button is operated.

6. The monitoring apparatus according to claim 5, wherein the data processing unit starts or stops sampling the data signals of the I²C bus according to the trigger signal.

7. The monitoring apparatus according to claim 1, wherein the data processing unit is a complex programmable logic device (CPLD) chip or a digital signal processing (DSP) chip.

8. The monitoring apparatus according to claim 1, wherein the storage unit is a static random access memory.

9. A monitoring apparatus for monitoring an inter integrated circuit (I²C) bus, the monitoring apparatus comprising:
a signal obtaining unit, a data processing unit, a storage unit and a communication control unit, the data processing unit coupled to the signal obtaining unit, the storage unit, and the communication control unit, wherein:
the signal obtaining unit is electrically coupled with both a serial data (SDA) line and a serial clock (SCL) line of the (I²C) bus, and is configured to obtain data signals and clock signals transmitted by the I²C bus;
the data processing unit is configured to analyze the data signals and the clock signals obtained by the signal obtaining unit, sample the obtained data signals at time intervals, and store the sampled data in the storage unit; and
the communication control unit communicates with a computing device and is configured to acquire the data stored in the storage unit and transmit the data to the computing device to display.

10. The monitoring device according to claim 9, wherein the communication control device is further configured to control the data processing unit to start or stop sampling the data signals from the 12C bus according to a control command sent from the computing device.

11. The monitoring device according to claim 9, further comprising a trigger button electrically coupled to the data processing unit and configured to send a trigger signal to the data processing unit when the trigger button is operated.

12. The monitoring device according to claim 11, wherein the data processing unit starts or stops to sample the data signals from the I²C bus according to the trigger signal.

13. The monitoring apparatus according to claim 9, wherein the data processing unit is further configured to:
detect a start signal from the data signals and the clock signals obtained by the signal obtaining unit and record the start signal using a first digital number;
sample each byte of the data signals and an acknowledge (ACK) bit following each byte of the data signals during each high period of the clock signals;
detect if the ACK bit following each byte of the sampled data signals is high or low, record the ACK bit in the storage unit using a second digital number if the ACK bit is low, and record the ACK bit in the storage unit using a third digital number the data processing unit if the ACK bit is high; and
record a stop signal in the storage unit using a fourth digital number when the stop signal is detected by the data processing unit.

14. The monitoring apparatus according to claim 13, wherein the first, second, third, an fourth digital numbers are stored in even addresses of a predetermined storage section of the storage unit, and each byte of the data signals sampled by the data processing unit are stored in odd addresses of the predetermined storage section storage unit.
